(19) United States
(12) Patent Application Publication
(10) Pub. No.: US 2007/0018905 A1
(43) Pub. Date: Jan. 25, 2007

(54) Antenna unit capable of maintaining a position of an antenna body with stability

(75) Inventors: Takao Kato, Akita (JP); Arata Togashi, Akita (JP); Hisashi Takisawa, Akita (JP); Junichi Noro, Akita (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Mitsumi Electric Co., Ltd., Tokyo (JP)

(21) Appl. No.: 11/477,289

(22) Filed: Jun. 29, 2006

(30) Foreign Application Priority Data
Jul. 19, 2005 (JP) 2005-209109
Jan. 25, 2006 (JP) 2006-16042

(51) Int. Cl. H01Q 1/50

(52) U.S. Cl. 343/906; 343/715

(57) ABSTRACT

A pole-type antenna unit has an pole-type antenna body having a cylinder extending up and down, a clip member, a universal joint for movably coupling the antenna body to the clip member. The clip member has an extending portion for extending from a bottom portion of the clip member, a ball joint provided to a tip of the extending portion, a half-cylinder mounted on the cylinder, and a grasping portion, fixed on the half-cylinder, for grasping the ball joint. The universal joint further has a non-slip ring-shaped packing disposed between the ball joint and the grasping portion. The grasping portion is fixed on the half-cylinder toward a lower position from a central portion thereof.

This application claims priority to prior Japanese patent applications JP 2005-209109 and JP 2006-16042, the disclosures of which are incorporated herein by reference.

### BACKGROUND OF THE INVENTION

This invention relates to an antenna unit mounted and, in particular, to a mounting structure of a personal-type miniature antenna unit for use in a digital radio receiver for receiving an electric wave from an artificial satellite (that may be called a “satellite wave”) or an electric wave on the ground (that may be called a “terrestrial wave”) to listen in digital radio broadcasting.

In recent years, a digital radio receiver, which receives the satellite wave or the terrestrial wave to listen the digital radio broadcasting, has been developed and is put to practical use in the United States of America. The digital radio receiver is generally mounted on a mobile station such as an automobile, and can receive an electric wave having a frequency of about 2.3 gigahertz (GHz) to listen in radio broadcasting. That is, the digital radio receiver is a radio receiver which can listen in a mobile broadcasting. Inasmuch as the received wave has the frequency of about 2.3 GHz, a reception wavelength (resonance frequency) A thereof is equal to about 128.3 mm. In addition, the terrestrial wave is an electric wave in which a signal where the satellite wave is received in an earth station is frequency shifted a little and is retransmitted in a linearly polarized wave. That is, the satellite wave is a circularly polarized wave while the terrestrial wave is the linearly polarized wave.

As described above, inasmuch as the electric wave having the frequency of about 2.3 GHz is used in the digital radio broadcasting, an antenna unit for receiving such an electric wave should be installed outdoors.

As digital radio receivers, there are a type adapted to be mounted in an automobile, a type adapted to be installed in a house or the like, and a type that is portable using a battery as a power source.

As a specific example of the portable digital radio receiver, there is available a portable electronic device such as a portable sound device. This portable electronic device comprises, in addition to a digital tuner for listening to the digital radio broadcasting, for example, an optical disc drive for reproducing an optical disc such as a compact disc (CD), an amplifier, and a speaker, which are integrally incorporated in a case.

On the other hand, there have been proposed antennas with various structures that are adapted to receive the electric wave having the frequency of about 2.3 GHz. Based on the shapes, they are roughly classified into a planar type (plate type) such as a patch antenna and a cylindrical type such as a loop antenna or helical antenna. Such an antenna of the planar or cylindrical type is prepared as a separate member from the case of the foregoing portable electronic device and is connected to the digital radio tuner incorporated in the case through a cable and a connector so as to be used.

Generally, the antennas of the cylindrical type are more used than the antennas of the planar type because a wider directivity can be achieved by making the shape of the antenna cylindrical.

Now, description will be made about a helical antenna being one of the antennas of the cylindrical type (see, e.g. Japanese Unexamined Patent Application Publication (JP-A) No. 2001-339227 which corresponds to U.S. Pat. No. 6,787,081 B2). The helical antenna has a structure in which at least one conductor is wound around a hollow or solid cylindrical (hereafter collectively referred to as “cylindrical”) member in a helical (spiral) fashion. The helical antenna can efficiently receive the foregoing circularly polarized wave. Accordingly, the helical antenna is used exclusively for receiving the satellite wave. The cylindrical member is made of an insulating material such as plastic. A plurality of conductors, for example, four conductors, are generally used for improving reception sensitivity. On the other hand, it is actually quite different to wind the plurality of conductors around the cylindrical member in the helical fashion. In view of this, it has been proposed to produce a flexible insulating film member having one surface printed with an antenna pattern composed to a plurality of conductors (hereinafter referred to as an “insulating film member with antenna pattern”) and then roll the insulating film member with antenna pattern into a hollow cylinder such that the foregoing one surface becomes an outer peripheral surface, thereby manufacturing a helical antenna (see, e.g. Japanese Unexamined Patent Application Publication (JP-A) No. 2003-37430 which corresponds to U.S. Pat. No. 6,791,509 B2)

In the case of the helical antenna having the structure in which the plurality of conductors are wound around the cylindrical member in the helical fashion, after a satellite wave (circularly polarized wave) is received by the plurality of helical conductors as a plurality of received waves, the received waves are phase-shifted by a phase shifter so as to be matched (adjusted) in phase, thereby obtaining a combined wave, and then the combined wave is amplified by a low-nose amplifier (LNA) and sent to a receiver. Herein, a combination of the helical antenna, the phase shifter, and the low-noise amplifier is called an antenna unit.

On the other hand, there has also been proposed an antenna unit comprising a helical antenna in the form of an antenna pattern formed on an outer peripheral surface of a cylindrical member, and a phase shifter in the form of a phase shifter pattern formed on the outer peripheral surface of the cylindrical member so as to be continuous with (connected to) the antenna pattern (see, e.g. Japanese Unexamined Patent Application Publication (JP-A) No. 2001-339228 which corresponds to U.S. Pat. No. 6,429,830 B2)

Such an antenna unit is placed in a topped hollow cylindrical cover case (cylinder) in order to prevent water invasion. Accordingly, the external appearance of the overall antenna unit exhibits a pole shape. In view of this, the antenna unit having such external appearance is called a pole-type antenna unit. Such the pole-type antenna unit is used while being carried, i.e. clipped to a pocket or the like, it is disposed in close proximity to the human body.

In such a pole-type antenna unit, conventionally, a clip is fixedly mounted on a cylinder portion of the cylindrical cover case (cylinder) of a pole-type antenna body. In contemplation of antenna characteristics such as an antenna's directivity of the pole-type antenna unit, it is preferable that a top portion of the pole-type antenna body always turns to a direction of the zenith in order to effectively receive an electric wave from the artificial satellite.

In a case where the pole-type antenna unit is mounted to a pocket with the pocket pinched using the clip, it is possible to easily turn the top portion of the pole-type antenna body in the direction of the zenith. In this event, inasmuch as the pole-type antenna body is disposed in close proximity to the human body, the antenna characteristics may be affected by the human body. Accordingly, it is desirable to mount the pole-type antenna body to a position which is apart from the human body as far as possible and which is as upward as possible.

Hence, it is considered that the pole-type antenna unit is mounted by catching the pole-type antenna unit to, for example, a brim of a hat by using a clip. However, in this event, inasmuch as the clip is fixedly mounted on a cylinder portion of an outer case, it is difficult to mount the pole-type antenna unit so as to turn the top portion of the pole-type antenna body in the direction of the zenith with respect to the brim (a mounted portion) of the hat.

Such a problem may be happened in a case of a planer-type antenna unit as well as a case of the pole-type antenna unit.

In addition, various types of techniques related to clips are previously proposed in the art although these techniques do not relate to the pole-type antenna unit. For example, an attaching mechanism for a GPS antenna that can be detachably attached to a display panel of a personal computer and easily define the horizontal plane thereof is known (see, e.g. Japanese Unexamined Patent Application Publication (JP-A) Hei No. 11-74712 which corresponds to U.S. Pat. No. 6,067,057). The attaching mechanism disclosed in U.S. Pat. No. 6,067,057 comprises a clip, having a shaft supporting member, for gripping a display panel of a portable personal computer when in an open position, a shaft in which one end thereof is supported by she shaft supporting member, and a base member fixed to the other end of the shaft. With such a structure of the attaching mechanism for the GPS antenna, the base member is rotated around the shaft on which a GPS antenna is mounted.

In the attaching mechanism disclosed in U.S. Pat. No. 6,067,057, inasmuch as it is necessary to rotate the base member around the shaft and to hold the base member, it is impossible to make holding force for holding the base member highly. Accordingly, it is difficult to keep on maintaining a posture (a position) of an antenna body for a long time with stability.

In addition, technique related to a clip structure that can be used with a clip rotated is proposed (see, e.g. Japanese Unexamined Patent Application Publication (JP-A) No. 2004-74446 which corresponds to U.S. Pat. No. 6,981,298 B2). The clip structure disclosed in U.S. Pat. No. 6,981,298 B2 includes a clip body that is formed into a substantial U shape to form a holding portion in which a thin object to be clipped is held, a clip securing member for securing the clip body so that a side of an opening of the clip body can rotate along an arc and stop, and an elastic body that urges the clip body along a rotation axis of the clip body toward the slip securing member.

Although the clip structure disclosed in U.S. Pat. No. 6,981,298 B2 discloses one that can be used with the clip rotated, it is necessary to provide the elastic body that urges the clip body along the rotation axis of the clip body toward the clip securing member in order to enable to rotate and stop the clip body with respect to the clip securing member. That is, the clip structure disclosed in U.S. Pat. No. 6,981,298 is disadvantageous in that it has an increased number of parts.

In addition, inasmuch as the clip structure disclosed in U.S. Pat. No. 6,981,298 B2 is one that can be used with the clip rotated, its technical idea is completely different from that where an antenna is supported by using a clip with stability in the manner of this invention of interest. In other words, the clip structure disclosed in U.S. Pat. No. 6,981,298 dose not have structure for supporting any one by using the clip because it is necessary to rotate the clip but has structure which can easily rotate the clip. On the other hand, inasmuch as it is necessary for this invention of interest to support an antenna body by using a clip, it is necessary to support the antenna body with its position maintained after positioning once. Accordingly, in the similar manner of the attaching mechanism disclosed in U.S. Pat. No. 6,067,057, the clip structure disclosed in U.S. Pat. No. 6,981,298 B2 is also disadvantageous in that it is difficult to keep on maintaining a posture (a position) of the antenna body for a long time with stability.

### SUMMARY OF THE INVENTION

It is therefore an object of the present invention to provide an antenna unit which is capable of mounting an antenna body to an mounted portion in a desired orientation.

It is another object of the present invention to provide an antenna unit of the type described, which is capable of mounting the antenna body to the mounted portion so as to aim a top portion of the antenna body at a direction of the zenith.

It is still another object of the present invention to provide an antenna unit of the type described, which is capable of keeping on maintaining posture (a position) of the antenna body for a long time with stability.

It is yet another object of the present invention to provide an antenna unit of the type described, which is capable of decreasing a parts count of the antenna unit.

Other objects of this invention will become clear as the description proceeds.

According to this invention, an antenna unit comprises an antenna body, a clip member, and a joint member for coupling the antenna body to the clip member so as to enable to adjust a mounting orientation of the antenna body with respect to the clip member.

In the antenna unit according to a first aspect of this invention, the joint member comprises a universal joint for movably coupling the antenna body to the clip member. The universal joint comprises an extending portion for extending from a bottom portion of the clip member, a ball joint provided to a tip of the extending portion, a fixing member mounted on the antenna body, and a grasping portion, fixed to the fixing member, for grasping the ball joint.

In the antenna unit according to the first aspect of this invention, the universal joint preferably may further comprise a non-slip ring-shaped packing disposed between the ball joint and the grasping portion. The antenna body may comprise a pole-type antenna body having a cylinder extending up and down. In this event, the fixing portion may comprise a half-cylinder mounted on the cylinder. The grasping portion preferably may be fixed on the half-cylinder toward a lower position from a central portion thereof. In addition, the grasping portion may comprise an upper wall, a lower wall, a right-hand wall, and a left-hand wall. Each of at least the lower wall, the right-hand wall, and the left-hand wall desirably may have a notch having a width larger than a diameter of the extending portion.

In addition, the antenna body may comprise a planar-type antenna body. In this event, the fixing member may comprise a base portion mounted on a bottom portion of the planar-type antenna body. The grasping portion preferably may be fixed to the base portion at a center thereof. The grasping portion may comprises four walls in all directions thereof. Each of the four walls desirably may have a notch having a width larger than a diameter of the extending portion.

In the antenna unit according to a second aspect of this invention, the universal joint may comprise a fixing member mounted on the antenna body, an extending portion for extending from the fixing member, a ball joint provided at a tip of the extending portion, and a grasping portion, fixed to a bottom portion of the clip member, for grasping the ball joint.

In the antenna unit according to the second aspect of this invention, the universal joint preferably may further comprise a non-slip ring-shaped packing disposed between the ball joint and the grasping portion. The antenna body may comprise a pole-type antenna body having a cylinder extending up and down. In this event, the fixing portion may comprise a half-cylinder mounted on the cylinder. The extending portion desirably may be fixed on the half-cylinder toward a lower position from a central portion thereof.

The antenna body may comprise a planar-type antenna body. In this event, the fixing member may comprise a base portion mounted on a bottom portion of the planar-type antenna body. The extending portion desirably may be fixed to the base portion at a center thereof.

In the antenna unit according to a third aspect of this invention, the joint member comprises a detachable/attachable joint for removably coupling the antenna body to the clip member with a variable mounting angle. The detachable/attachable joint comprises a fixing member mounted on the antenna body, an accepting portion mounted on the fixing member, and a projection portion mounted on the clip member. The projection portion is fitted in the accepting portion. The antenna body may comprise a pole-type antenna body having a cylinder extending up and down. In this event, the fixing portion may comprise a half-cylinder mounted on the cylinder. The accepting portion preferably may be fixed on the half-cylinder toward a lower position from a central portion thereof.

In the antenna unit according to a third aspect of this invention, the clip member may enable to be mounted on the fixing member with changing an orientation of the clip member by an angle of (360/N) degrees, where N represents an integer which is not less than three. Concretely, the integer N may be equal to four. In this event, the clip member may enable to be mounted on the fixing member with changing the orientation of the clip member by the angle of 90 degrees. The accepting portion may have a substantially hollow square tubular shape and may have an accepting space for accepting the projection portion in an interior thereof. The projection portion may have a substantially octagonal tubular shape having a size which enables to be fitted in the accepting space of the accepting portion. In this event, the accepting portion desirably comprise, at four corners thereof, four cylindrical protrusions for positioning the projection portion and an upper accepting wall, a lower accepting wall, a left-hand accepting wall, and a right-hand accepting wall which connect between the four cylindrical protrusions. The projection portion desirably may comprise an upper projection wall, a lower projection wall, a left-hand projection wall, a right-hand projection wall, and four chamfered walls for linking between the upper projection wall, the lower projection wall, the left-hand projection wall, and the right-hand projection wall to be slidably in contact with the four cylindrical protrusions. In addition, each of the upper accepting wall, the lower accepting wall, the left-hand accepting wall, and the right-hand accepting wall of the accepting portion desirably may have an inner wall having an engaging projection for removably engaging with the projection portion. Each of the upper projection wall, the lower projection wall, the left-hand projection wall, and the right-hand projection wall of the projection portion desirably have an outer wall having an engaged concave portion which is engaged with the corresponding engaging projection.

### BRIEF DESCRIPTION OF THE DRAWINGS

FIG. 1 is a schematic exploded front view showing a pole-type antenna body to which this invention is applied;

FIGS. 2A and 2B are developed views each of helical antenna portion and a phase shifter portion used in the pole-type antenna body illustrated in FIG. 1, wherein FIG. 2A is a plan view showing a first surface (inner peripheral surface) and FIG. 2B is a plan view showing a second surface (outer peripheral surface);

FIG. 3 is an exploded rear view showing the pole-type antenna body illustrated in FIG. 1 with a cover case removed;

FIG. 4 is an exploded rear view showing the pole-type antenna body illustrated in FIG. 1 with a hollow cylindrical member removed;

FIG. 5 is an exploded side view of the pole-type antenna body illustrated in FIG. 4;

FIG. 6 is a sectional view of an undercap used in the pole-type antenna body illustrated in FIG. 1;

FIGS. 7A, 7B, and 7C are views showing a packing used in the pole-type antenna body illustrated in FIG. 1, wherein FIG. 7A is a front view, FIG. 7B is a plan view, and FIG. 7C is a sectional view taken along line B-B in FIG. 7B;

FIG. 8 is an exploded front sectional view of the pole-type antenna body illustrated in FIG. 1;

FIG. 9 is a font view showing the external appearance of the pole-type antenna body illustrated in FIG. 1;

FIG. 10 is a front sectional view of the pole-type antenna body illustrated in FIG. 1;

FIG. 11 is an exploded side view for explaining a positional relationship between a board and the hollow cylindrical member used in the pole-type antenna body illustrated in FIG. 1;

FIG. 12 is an exploded rear view for explaining the positional relationship between the board and the hollow cylindrical member illustrated in FIG. 11;

FIG. 13 is a rear view showing the state where the board and the hollow cylindrical member illustrated in FIG. 11 are assembled together;

FIG. 14 is an enlarged view of an encircled portion in FIG. 13;

FIG. 15 is a diagram showing return loss characteristics of the pole-type antenna body with first and second annular cushion members illustrated in FIG. 1 and a conventional pole-type antenna unit without the first and second annular cushion members;

FIGS. 16A, 16B, 16C, 16D, and 16E are views showing a pole-type antenna unit according to a first embodiment of this invention, wherein FIG. 16A is a front view, FIG. 16B is a right-hand side view, and FIG. 16C is a left-hand side view, FIG. 16D is a plan view, and FIG. 16E is a bottom view;

FIG. 17 is a perspective view of the pole-type antenna unit illustrated in FIGS. 16A to 16E;

FIG. 18 is an exploded perspective view of the pole-type antenna unit illustrated in FIGS. 16A to 16E;

FIG. 19 is an exploded right-hand side view of the pole-type antenna unit illustrated in FIGS. 16A to 16E;

FIG. 20 is a front view of the pole-type antenna unit illustrated in FIGS. 16A to 16E showing a state where a clip member is bent with respect to the antenna body downward;

FIG. 21 is a left-hand side view of the pole-type antenna unit illustrated in FIGS. 16A to 16E showing a state where the clip member is bent with the antenna body rightward

FIG. 22 shows a state where the pole-type antenna unit illustrated in FIGS. 16A to 16E is mounted to a brim of a hat by using the clip member;

FIG. 23 show a state where the pole-type antenna unit illustrated in FIGS. 16A to 16E is mounted to the brim of the hat by using the clip member;

FIG. 24 is an exploded right-hand side view of a modified pole-type antenna unit into which the pole-type antenna unit illustrated in FIGS. 16A and 16E is modified;

FIGS. 25A, 25B, 25C, 25D, and 25E are views showing a planar-type antenna unit according to a second embodiment of this invention, wherein FIG. 25A is a front view, FIG. 25B is a bottom view, FIG. 25C is a right-hand side view, and FIG. 25D is a left-hand side view, and FIG. 25E is a rear view;

FIG. 26 is a perspective view of the planar-type antenna unit illustrated in FIGS. 25A to 25E;

FIG. 27 is an exploded perspective view of the planar-type antenna unit illustrated in FIGS. 25A to 25E;

FIG. 28 is an exploded front view of the planar-type antenna unit illustrated in FIGS. 25A to 25E;

FIG. 29 is an exploded perspective view showing the planar-type antenna unit illustrated in FIGS. 25A to 25E with a planar-type antenna body side and a clip member side exploded;

FIG. 30 is an exploded front view of a modified planar-type antenna unit into which the planar-type antenna unit illustrated in FIGS. 25A and 25E is modified;

FIGS. 31A, 31B, 31C, and 31D are views which show a clip member and a joint member for use in a pole-type antenna unit according to a third embodiment of this invention and which show an example where the clip member is mounted to a half-cylinder in an upward mounting state so that an opening of the clip member turns upwards with respect to the half-cylinder, wherein FIG. 31A is an exploded right-hand side view of the upward mounting state, FIG. 31B is an exploded perspective view of the upward mounting state seen from a right-hand and forward, FIG. 31C is an exploded perspective view of the upward mounting state seen from the right-hand and rearward, and FIG. 31D is an exploded perspective view of the upward mounting state seen from a front and rightward;

FIGS. 32A, 32B, 32C, and 32D are views showing an assembled state where the upward mounting state illustrated in FIGS. 31A to 31D is assembled, wherein FIG. 32A is an assembled right-hand side view of the upward mounting state, FIG. 32B is an assembled perspective view of the upward mounting state seen from a right-hand and forward, FIG. 32C is an assembled perspective view of the upward mounting state seen from the right-hand and rearward, and FIG. 32D is an assembled perspective view of the upward mounting state seen from a front and rightward;

FIGS. 33A, 33B, 33C, and 33D are views which show the clip member and the joint member for use in the pole-type antenna unit according to the third embodiment of this invention and which show an example where the clip member is mounted to the half-cylinder in a rightward mounting state so that the opening of the clip member turns rightwards with respect to the half-cylinder, wherein FIG. 33A is an exploded right-hand side view of the rightward mounting state, FIG. 33B is an exploded perspective view of the rightward mounting state seen from a right-hand and forward, FIG. 33C is an exploded perspective view of the rightward mounting state seen from the right-hand and rearward, and FIG. 33D is an exploded perspective view of the rightward mounting state seen from a front and rightward;

FIGS. 34A, 34B, 34C, and 34D are views showing an assembled state where the rightward mounting state illustrated in FIGS. 33A to 33D is assembled, wherein FIG. 34A is an assembled right-hand side view of the rightward mounting state, FIG. 34B is an assembled perspective view of the rightward mounting state seen from a right-hand and forward, FIG. 34C is an assembled perspective view of the rightward mounting state seen from the right-hand and rearward, and FIG. 34D is an assembled perspective view of the rightward mounting state seen from a front and rightward;

FIGS. 35A, 35B, 35C, 35D, and 35E are views showing a half-cylinder with an accepting portion for use in the pole-type antenna unit according to the third embodiment of this invention, wherein FIG. 35A is a front view of the half-cylinder with the accepting portion, FIG. 35B is a plan view of the half-cylinder with the accepting portion, FIG. 35C is a right-hand side view of the half-cylinder with the accepting portion, FIG. 35D is a cross-sectional view taken on line C-C of FIG. 35A, and FIG. 35E is a cross-sectional view taken on line D-D of FIG. 35A;

FIG. 36 is an enlarged view of the accepting portion in an encircled portion E of FIG. 35A;

FIG. 37 is an enlarged view of the accepting portion in an encircled portion F of FIG. 35E;

FIGS. 38A, 38B, 38C, 38D, 38E, and 38F are view showing a clip member with a projection portion for use in the pole-type antenna unit according to the third embodiment of this invention, wherein FIG. 38A is a front view of the clip member with the projection portion, FIG. 38B is a plan view of the clip member with the projection portion, FIG. 38D is a right-hand side view of the clip member with the projection portion, FIG. 38D is a left-hand side view of the clip member with the projection portion, FIG. 38E is a bottom view of the clip member with the projection portion, and FIG. 38F is a rear view of the clip member with the projection portion;

FIG. 39 is a cross-sectional view taken on line G-G of FIG. 38A;

FIG. 40 is a cross-sectional view taken on line H-H of FIG. 39;

FIG. 41 is a cross-sectional view taken on line I-I of FIG. 39; and

FIG. 42 is a cross-sectional view taken on line J-J of FIG. 38C.

### DESCRIPTION OF THE PREFERRED EMBODIMENTS

Now, embodiments of this invention will be described in detail with reference to the drawings.

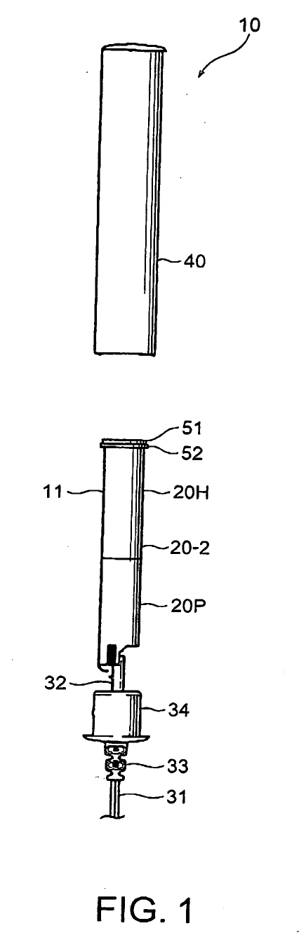

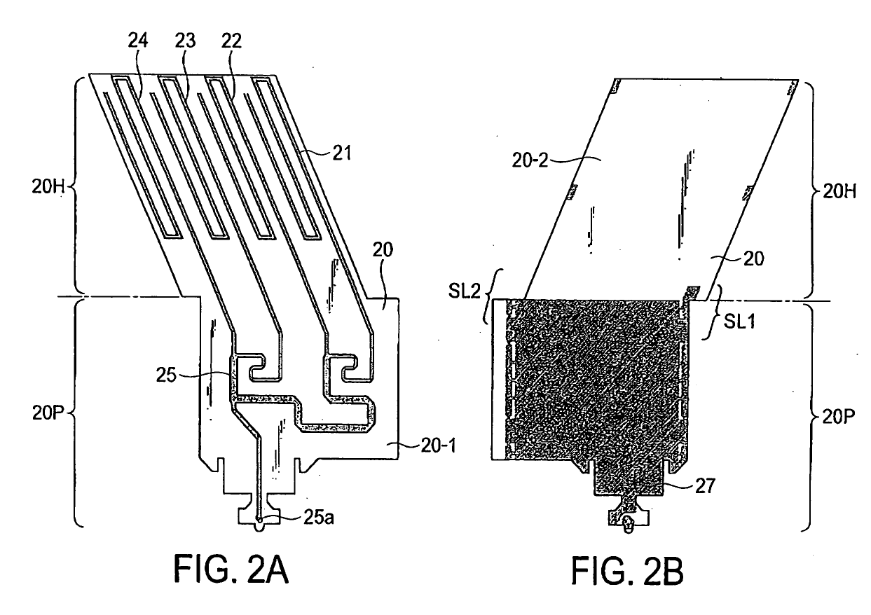

Referring to FIG. 1 and FIGS. 2A and 2B, a pole-type antenna body 10 to which this invention is applicable will be described at first in order to facilitate an understanding of the present invention. The illustrated pole-type antenna body 10 is an antenna body for a digital radio receiver and is connected to a digital radio tuner (not shown) incorporated in a housing of a portable electronic device (not shown) through a cable 31 and a connector (not shown) so as to be used.

In addition, in the manner which will later be described, a pole-type antenna unit according to this invention has a structure where a clip member and a joint member are mounted to the pole-type antenna body 10 illustrated in FIG. 1. In other words, the pole-type antenna body 10 is mounted to the clip member via the joint member with a variable mounting orientation.

The illustrated pole-type antenna body 10 comprises a hollow cylindrical member 11 formed by rolling a flexing insulating member 20 as shown in FIGS. 2A and 2B into a hollow cylinder. FIG. 2A shows a first surface 20-1 of the insulating film member 20 while FIG. 2B shows a second surface 20-2 of the insulating film member 20. The insulating film member 20 is composed of a helical antenna portion 20H and a phase shifter portion 20P. The helical antenna portion 20H has a substantially parallelogram shape while the phase shifter portion 20P has a substantially rectangular shape.

By connecting together a pair of lateral sides SL1 and SL2 of the insulating film member 20 so that the first surface 20-1 becomes as inner peripheral surface, the hollow cylindrical member 11 as shown in FIG. 1 is formed. The connection between the pair of lateral sides SL1 and SL2 is carried out, for example, by the use of double-sided adhesive tape, an adhesive agent, or soldering.

An antenna pattern comprising first through fourth conductors 21, 22, 23, and 24 is formed on the first surface 20-1 of the helical antenna portion 20H. Each of the first through the fourth conductors 21 to 24 is formed so as to extend in parallel to the lateral sides SL1 and SL2 of the helical antenna portion 20H in the state where each conductor is bent twice in opposite directions in the longitudinal direction of the pole-type antenna body 10. Therefore, when the insulating film member 20 is rolled so that the hollow cylindrical member 11 is formed as described above, each of the first through the fourth conductors 21 to 24 extends in a helical fashion on the inner peripheral surface of the hollow cylindrical member 11 in the state where each conductor is bent twice in the opposite directions in the longitudinal direction of the pole-type antenna body 10. The antenna pattern composed of the first through the fourth conductors 21 to 24 serves as a helical antenna.

As described above, in this embodiment, inasmuch as the first through the fourth conductors 21 to 24 are each bent in the longitudinal direction of the pole-type antenna body 10, the height of the pole-type antenna body 10 can be reduced as compared with the case where the conductors are not bent.

A phase shifter pattern 25 electrically connected to the foregoing antenna pattern is formed on the first surface 20-1 of the phase shifter portion 20P. Therefore, when the insulating film member 20 is rolled so that the hollow cylindrical member 11 is formed as described above, the phase shifter pattern 25 is formed on the inner peripheral surface of the hollow cylindrical member 11. This phase shifter pattern 25 acts as a phase shifter.

A ground pattern 27 is formed on the second surface 20-2 of the phase shifter portion 20P. That is, the ground pattern 27 is formed on the surface of phase shifter portion 20P of the opposite side with respect to the surface thereof where the phase shifter pattern 25 is formed. Therefore, when the insulating film member 20 is rolled so that the hollow cylindrical member 11 is formed as described above, the ground pattern 27 is formed on the outer peripheral surface of the hollow cylindrical member 11 on the opposite side with respect to the surface thereof where the phase shifter pattern 25 is formed. The ground pattern 27 is operable as a shield member provided so as to cover the phase shifter pattern 25.

The pole-type antenna body 10 further comprises a topped hollow cylindrical cover case (cylinder) 40 for covering the hollow cylindrical member 11. The cover case 40 has an inner diameter which is greater than the diameter of the hollow cylindrical member 11.

As described above, in this embodiment, inasmuch as the antenna pattern comprising the first through the fourth conductors 21 to 24 and forming the helical antenna portion is formed on the inner peripheral surface 20-1 of the hollow cylindrical member 11, there is no direct contact between the antenna pattern and an inner wall of the cover case 40. Therefore, antenna characteristics of the pole-type antenna body 10 can be prevented from being affected by the cover case 40. Further, inasmuch as the ground pattern 27 serving as the shield member is disposed on the outer side of the phase shifter pattern 25, the antenna characteristics of the pole-type antenna body 10 can be prevented from being affected by the human body. As a result, the pole-type antenna body 10 according to this embodiment can achieve desired antenna characteristics even during use.

In the example being illustrated, a first annular cushion member 51 is wound around the outer peripheral surface of the helical antenna portion 20H at its tip end. Further, just below the first annular cushion member 51, a second annular cushion member 52 is wound around the outer peripheral surface of the helical antenna portion 20H. The second annular cushion member 52 has a thickness which is slightly greater than a clearance between the hollow cylindrical member 11 and the cover case 40. The first and second annular cushion member 51 and 52 are made of, for example, urethane foam.

By winding the first annular cushion member 51 around the outer peripheral surface of the helical antenna portion 20H at its tip end as described above, it is possible to change permittivity of the helical antenna portion 20H at its tip end, thereby enabling adjustment of antenna frequency characteristics of the pole-type antenna body 10. Therefore, by changing the thickness or width of the first annular cushion member 51, it is possible to change the antenna frequency characteristics of the pole-type antenna body 10. At any rate, the annular cushion member 51 serves as a characteristic adjusting member for adjusting the antenna frequency characteristics of the pole-type antenna body 10.

On the other hand, the second annular cushion member 52 serves as a cushion between the inner wall of the cover case 40 and the helical antenna portion 20H so that the clearance between the inner wall of the cover case 40 and the helical antenna portion 20H can be maintained constant. Accordingly, inasmuch as it is possible to prevent an extreme inclination of the helical antenna portion 20H with respect to the cover case 40, variation in directivity of the pole-type antenna body 10 can be suppressed. As described above, inasmuch as the thickness of the second annular cushion member 52 is slightly greater than the clearance between the helical antenna portion 20H and the inner wall of the cover case 40, the second annular cushion member 52 is press-fitted into the cover case 40. As a result, the distance between the inner wall of the cover case 40 and the helical antenna portion 20H can be held constant. At any rate, the second annular cushion member 52 acts as a distance holding member for holding constant the distance between the hollow cylindrical member 11 and the inner wall of the cover case-40.

The pole-type antenna body 10 comprises a board 32, such as a printed circuit board. An electronic component such as a low-noise amplifier (LNA), which will be described later, is mounted on the board 32. The low-noise amplifier is connected to an output terminal 25a of the phase shifter pattern 25 and one end of the cable 31.

A satellite wave (circularly polarized wave) is received by the four conductors 21 to 24 of the helical antenna portion 20H as four received waves. The four received waves are phase-shifted by the phase shifter pattern 25 so as to be matched (adjusted) in phase, thereby obtaining a combined wave. Then, the combined wave is amplified by the low-noise amplifier and sent to a receiver unit (not shown) through the cable 31.

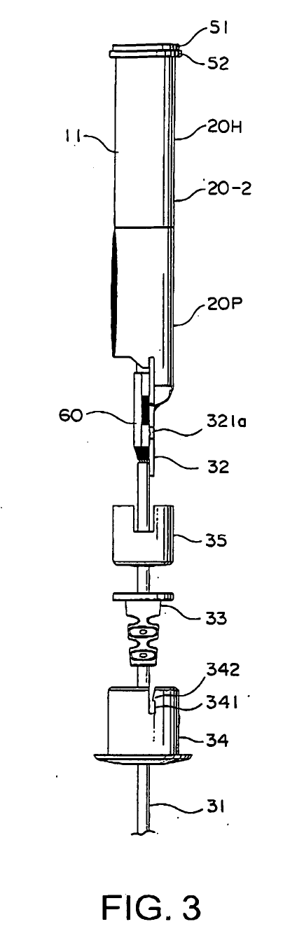

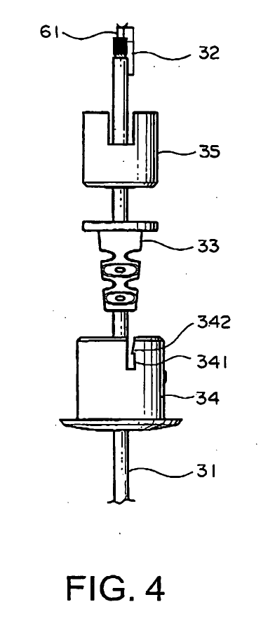

Referring also to FIGS. 3 through 5 in addition to FIG. 1, the pole-type antenna body 10 further comprises a boot 33 slidably attached to the cable 31. an undercap (bottom) 34 that is attached to a lower end of the cover case 40 as will be described later, and a waterproof packing 35. The boot 33 is made of polyurethane.

By disposing the boot 33 and the packing 35 in the undercap 34 and inserting the board 32 therein, there are provided a waterproof function on the cable 31 and a board fixing function.

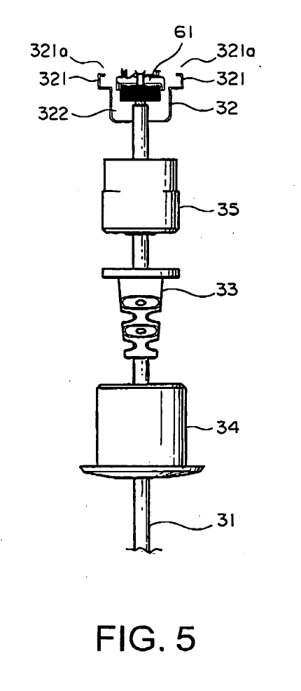

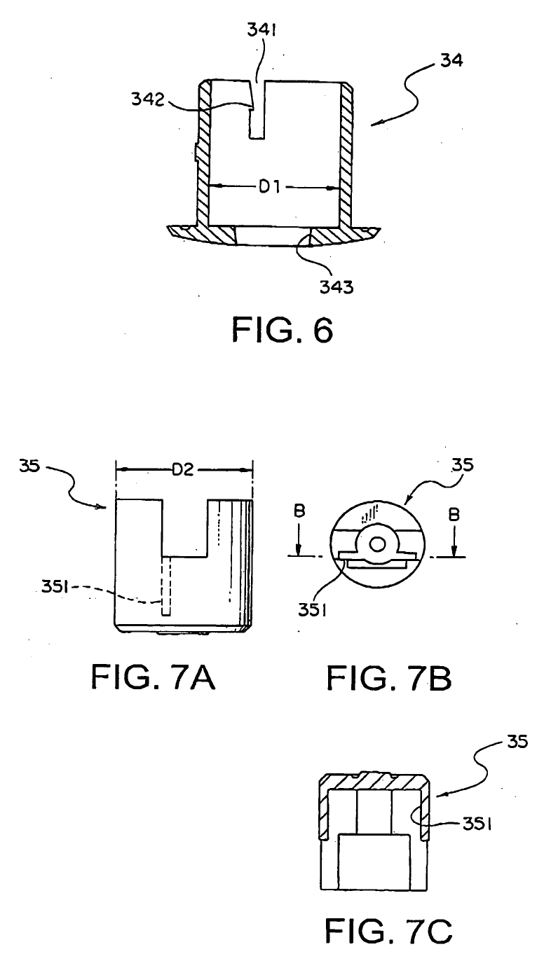

FIG. 6 is a sectional view of the undercap 34. As shown in FIG. 6, the undercap 34 is formed with a pair of notches 341 on its upper end side for receiving therein both side end portions 321 (FIG. 5) of the board 32. The undercap 34 is provided with a pawl 342 at each of the notches 341 in order to prevent the board 34 from returning back upon press-fitting thereof. Furthermore, the undercap 34 is formed at its lower end with an opening 343 in which the boot 34 is inserted.

As described above, the board 32 has the side end portions 321 projecting laterally from its both side surfaces. As shown in FIG. 3, each side end portion 321 of the board 32 is formed with a notch 321a for engagement with the corresponding pawl 342 of the notch 34.

FIGS. 7A, 7B, and 7C are views showing the packing 35, wherein FIG. 7A is a front view, FIG. 7B is a plan view, and FIG. 7C is a sectional view taken along line B-B in FIG. 7B. As shown in FIGS. 6 and 7A, the packing 35 had an outer diameter D2 which is slightly greater than an inner diameter D1 of the undercap 34. This is for press-fitting the packing 35 into the undercap 34. The packing 35 is formed with a notch 351 in which a lower end portion 322 (FIG. 5) of the board 32 is inserted.

By press-fitting the packing 35 into the undercap 34 and fixing such a press-fitted state by the board 32, the waterproof function on the cable 31 is realized. In this event, inasmuch as the board 32 is also fixed in the undercap 34, positioning of the board 32 ca also be carried out.

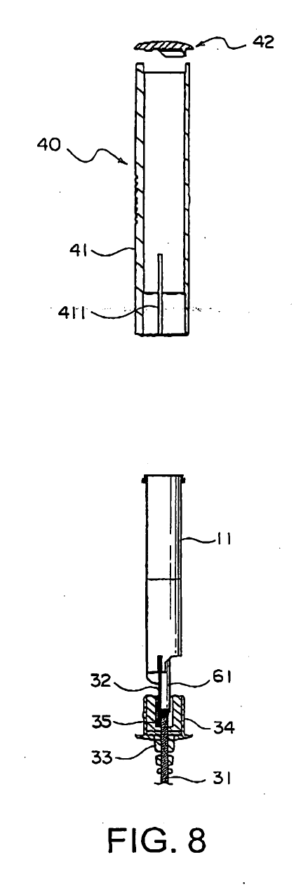

Referring to FIG. 8, the cover case 40 comprises a cylinder portion 41 and a top cover 42. The cylinder portion 41 is formed on its inner wall with a pair of grooves 411 for receiving therein the side end portions 321 of the board 32.

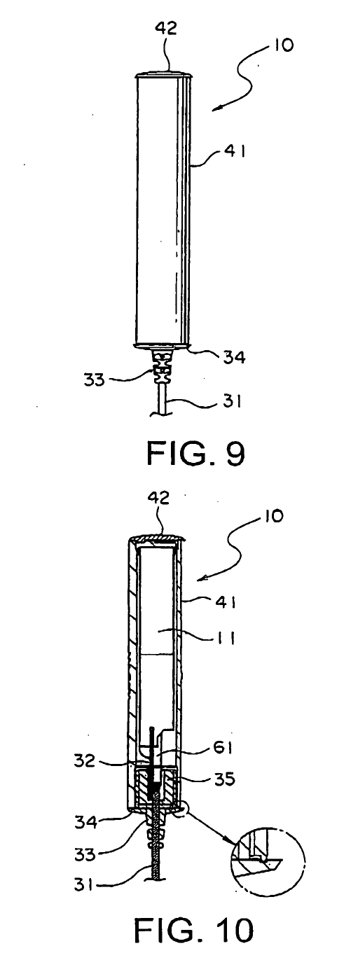

FIG. 9 is a front view showing the external appearance of the pole-type antenna body 10 and FIG. 10 is a sectional view of the pole-type antenna body 10. The top cover 42 is bonded to an upper end of the cylinder portion 41 by ultrasonic bonding. The undercap (bottom cover) 34 is bonded to a lower end of the cylinder portion 41 by ultrasonic bonding. Inasmuch as, as described above, the pole-type antenna body 10 has the structure using no screws, it is possible to reduce a parts count.

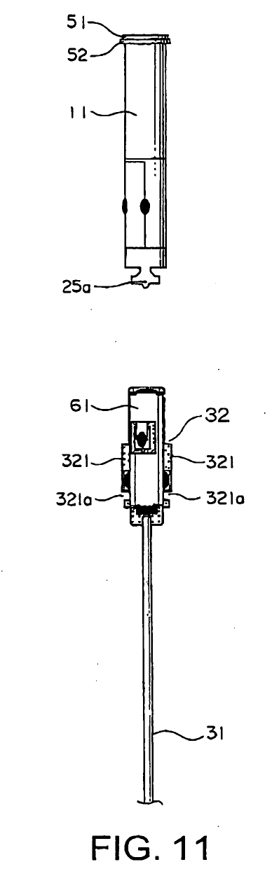

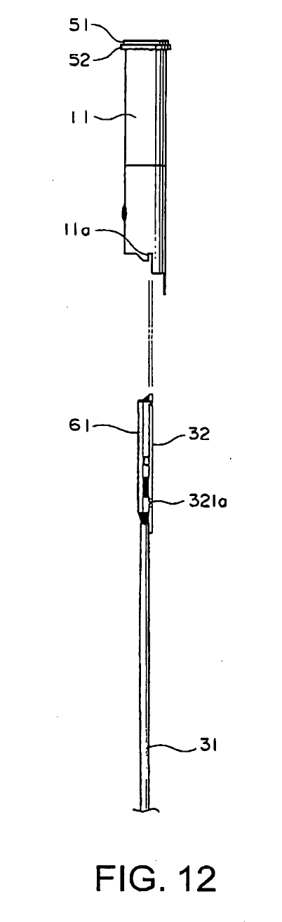

Referring to FIGS. 11 through 14, description will be made about a positional relationship between the board 32 and the hollow cylindrical member 11. The hollow cylindrical member 11 has a pair of notches 11a for receiving therein the side end portions 321 of the board 32.

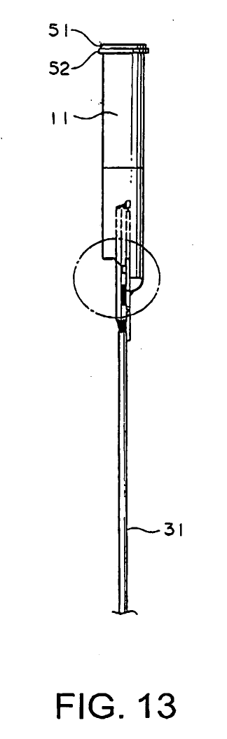

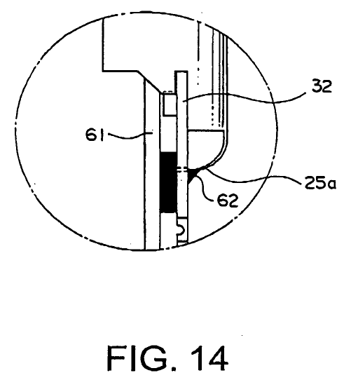

As shown in FIG. 13, a part of the board 32 mounted with a low-noise amplifier (LNA) 61 (FIG. 11) is inserted into the inside of the hollow cylindrical member 11. As shown in FIG. 14, the output terminal 25a of the hollow cylindrical member 11 is connected to the board 32 (the low-noise amplifier 61) by solder 62.

Inasmuch as the part of the board 32 is inserted into the inside of the hollow cylindrical member 11 as described above, it is possible to reduce the size of the pole-type antenna body 10 in its longitudinal direction. Further, inasmuch as the connection between the hollow cylindrical member 11 and the board 328 (the low-noise amplifier 61) is carried out by the use of the output terminal 25a formed at the flexible insulating film member 20, the particular or dedicated terminal component required in the conventional poly-type antenna unit becomes unnecessary and, therefore, it is possible to reduce a parts count,

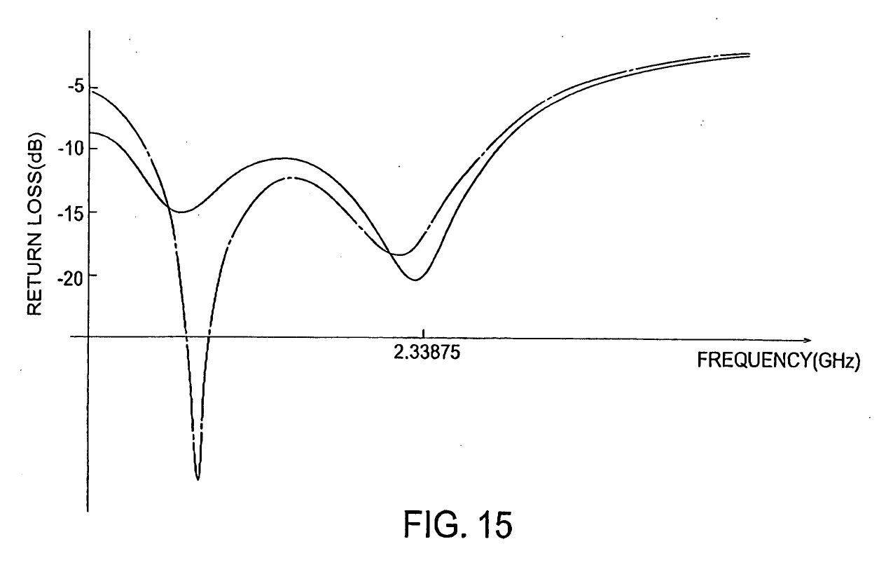

FIG. 15 shows return loss characteristics of the pole-type antenna body 10 (i.e. with the first and second annular cushion members 51 and 52) and a conventional pole-type antenna unit (i.e. without the first and second annular members 51 and 52). In FIG. 15, the abscissa represents frequency (GHz) and the ordinate represents return loss (dB). In FIG. 15, a solid line shows the return loss characteristics of the pole-type antenna body 10 according to this invention while a dot-dash line shows the return loss characteristics of the conventional pole-type antenna unit.

At a center frequency (2.33875 GHz), the pole-type antenna body 10 according to this invention has a return loss of −19.685 dB while the conventional pole-type antenna unit has a return loss of −16.685 dB. It is therefore understood that the return loss characteristics of the pole-type antenna body 10 according to this invention have been improved.

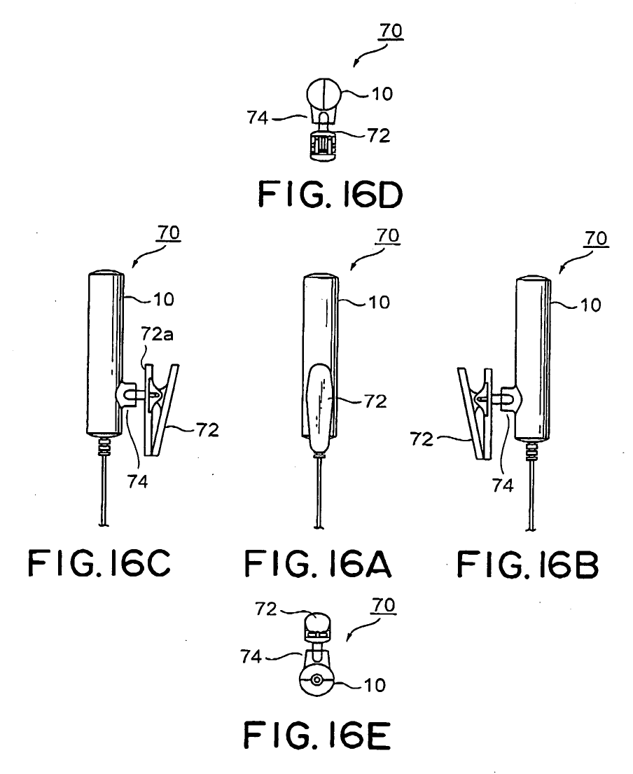

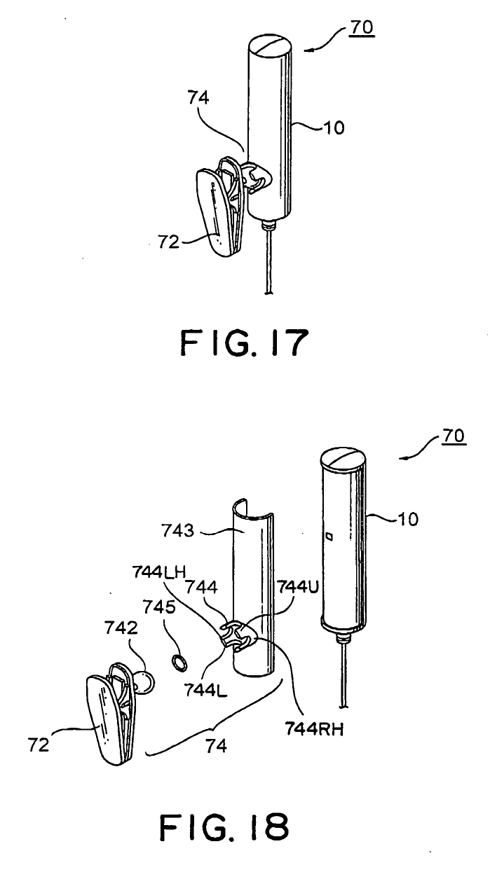

Referring to FIGS. 16A to 16E and FIGS. 17 through 19, the description will proceed to a pole-type antenna unit 70 according to a first embodiment of this invention. FIG. 16A is a front view of the pole-type antenna unit 70, FIG. 16B is a right-hand side view of the pole-type antenna unit 70, FIG. 16C is a left-hand side view of the pole-type antenna unit 70, FIG. 16D is a plan view of the pole-type antenna unit 70, and FIG. 16E is a bottom view of the pole-type antenna unit 70. FIG. 17 is a perspective view of the pole-type antenna unit 70. FIG. 18 is an exploded perspective view of the pole-type antenna unit 70. FIG. 19 is an exploded right-hand side view of the pole-type antenna unit 70.

The illustrated pole-type antenna unit 70 comprises the pole-type antenna unit 10, a clip member 72, and a universal joint 74 for movably coupling the pole-type antenna body 10 to the clip member 72.

The universal joint 74 comprises an extending portion 741 for extending from a bottom portion 72a of the clip member 72, a ball joint 742 provided to a tip of the extending portion 741, a half-cylinder 743 mounted to the outer case (the cylinder) 40 of the antenna body 10, a grasping portion 744 for grasping the ball joint 742. The grasping portion 744 is fixed on the half-cylinder 743 toward a lower position from a central portion thereof. In addition, the extending portion 741, the ball joint 742, and the grasping potion 744 are made of resin material such as acrylonitrile butadiene styrene (ABS) resin or the like. In the example being illustrated, the half-cylinder 743 is used as a fixing member mounted on the antenna body 10.

In addition, the universal joint 74 further comprises a non-slip ring-shaped packing 745 between the ball joint 742 and the grasping portion 744.

In the example being illustrated, the grasping portion 744 comprises an upper wall 744U, a lower wall 744L, a left-hand wall 744LH, and a right-hand wall 744RH. Each of the upper wall 744U, the lower wall 744L, the left-hand wall 744LH, and the right-hand wall 744RH has a notch 744a. The notch 744a has a width which is slightly larger than a diameter of the extending portion 741. That is, it is possible to receive the extending portion 741 in the notch 744a. With this structure, it is possible to bend the clip member 72 with respect to the antenna body 10 upward, downward, leftward, or rightward.

Although the notches 744a are provided with the upper wall 744U, the lower wall 744L, the left-hand wall 744LH, and the right-hand wall 744RH of the grasping portion 744, the notches 744a may be provided with only the right-hand wall 744RH, the left-hand wall 744LH, and the lower wall 744L except for the upper wall 744U. In this event, it is possible to bend the clip member 72 with respect to the antenna body 10 downward, leftward, or rightward.

Inasmuch as, in the example being illustrated, the grasping portion 744 is fixed on the half-cylinder toward the lower portion from the central portion thereof, it is possible to reduce an influence upon antenna characteristics of the pole-type antenna unit 70.

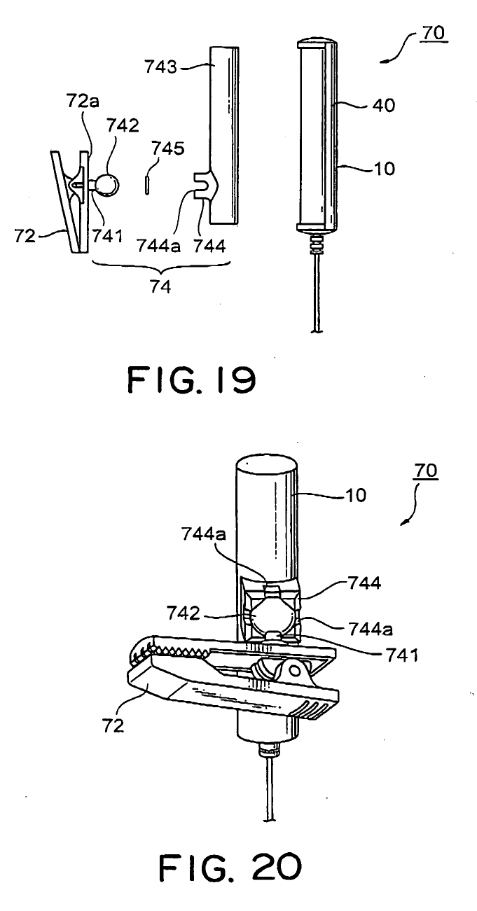

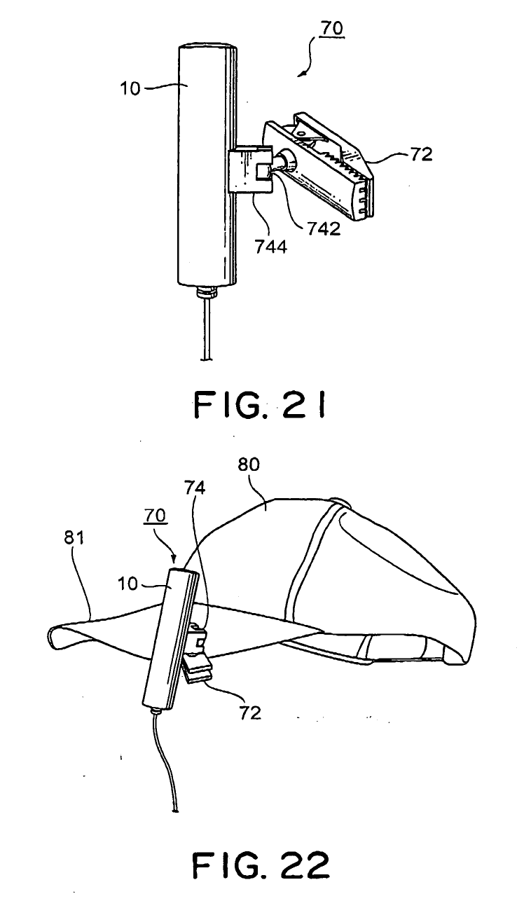

FIG. 20 is a front view showing a state where the clip member 72 is bent with respect to the antenna body 10 downward. FIG. 21 is a left-hand side view showing a state where the clip member 72 is bent with the antenna body 10 rightward.

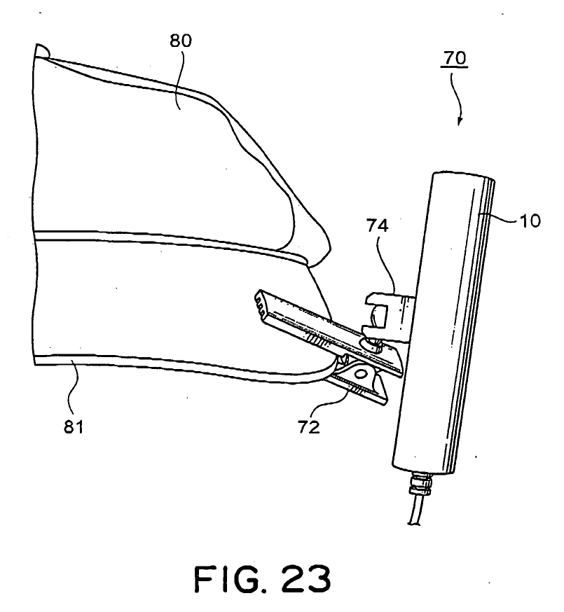

FIGS. 22 and 23 collectively show a state where the pole-type antenna unit 70 is mounted to a brim 81 of a hat 80 by using the clip member 72. As apparent from FIGS. 22 and 23, it is possible to easily turn a top portion of the pole-type antenna body 10 toward a direction of the zenith in a case where the pole-type antenna unit 70 is mounted to the brim 81 of the hat 80 by pinching the brim 81 by the clip member 72.

In other wards, it is possible to mount the pole-type antenna unit 70 to any mounted position (mounted portion) with the top portion of the pole-type antenna body 10 turned toward the direction of the zenith which has a good antenna's directivity.

Although the ball joint 742 is provided with the clip member 72 side and the grasping portion 744 is provided with the antenna body 10 side in the above-mentioned embodiment, vice versa.

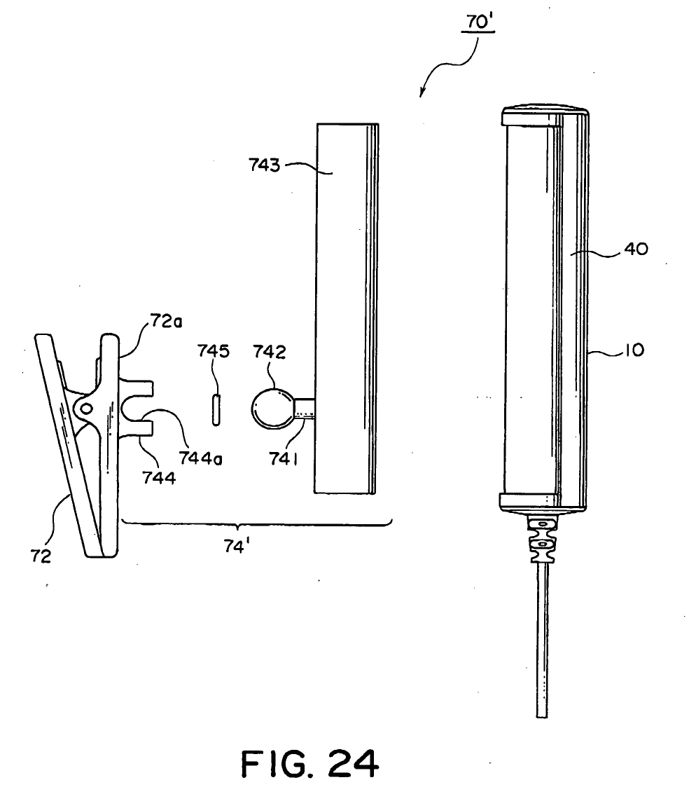

FIG. 24 is an exploded right-hand side view of a modified pole-type antenna unit 70′. The pole-type antenna unit 70′ comprises the pole-type antenna body 10, the clip member 72, and a universal joint 74′ which is modified from the universal joint 74 in the manner which will presently be described.

The universal joint 74′ comprises the half-cylinder 743 mounted on the outer case (the cylinder) 40 of antenna body 10, the extending portion 741 for extending from the half-cylinder 743, the ball joint 742 provided at a tip of the extending portion 741, and the grasping portion 744, which is fixed to the bottom portion 72a of the clip member 72, for grasping the ball joint 742. That is, in the pole-type antenna unit 70′, the ball joint 742 is provided with the antenna body 10 side and the grasping portion 744 is provided with the clip member 72 side.

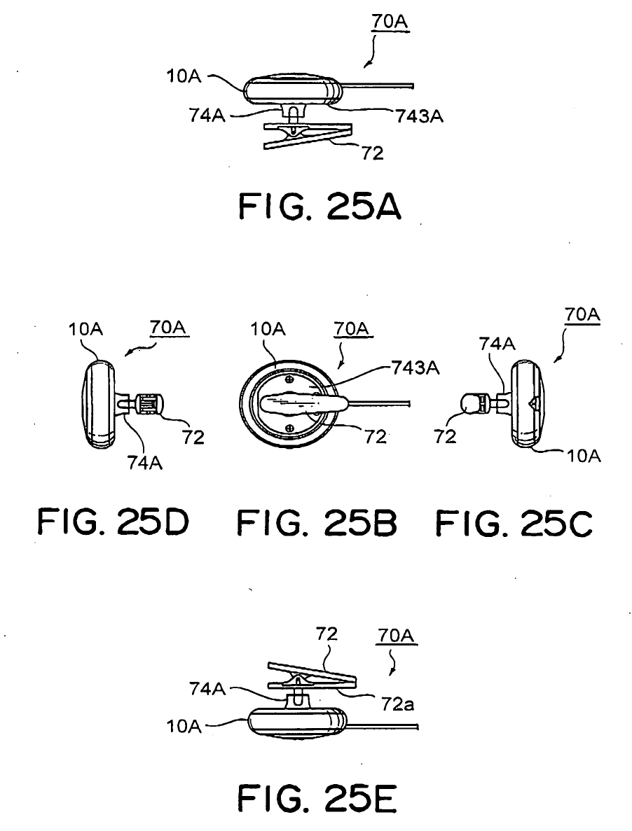

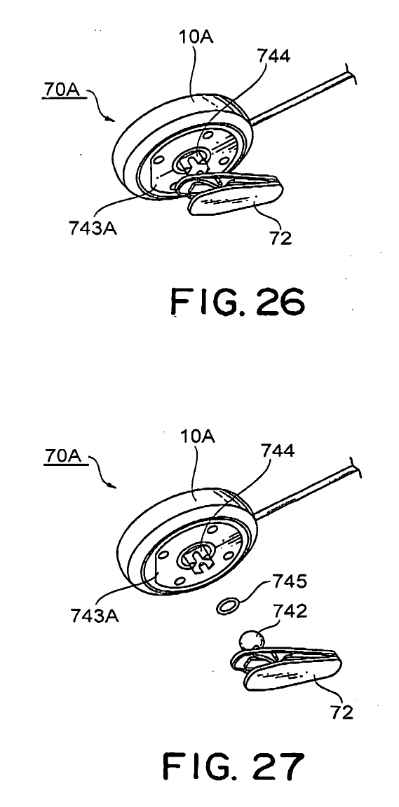

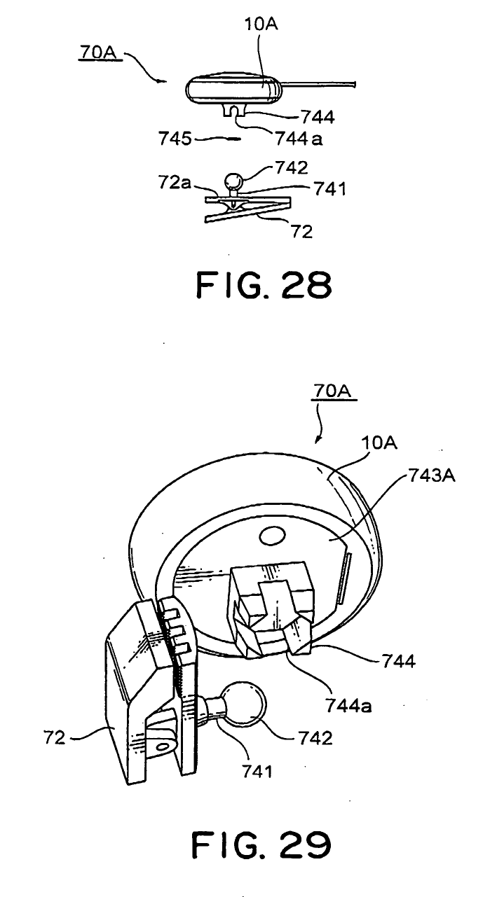

Referring to FIGS. 25A to 25E and FIGS. 26 through 28, the description will proceed to a planar-type antenna unit 70A according to a second embodiment of this invention. FIG. 25A is a front view of the planar-type antenna unit 70A, FIG. 25B is a bottom view of the planar-type antenna unit 70A, FIG. 25C is a right-hand side view of the planar-type antenna unit 70A, FIG. 25D is a left-hand side view of the planar-type antenna unit 70A, and FIG. 25E is a rear view of the planar-type antenna unit 70A. FIG. 26 is a perspective view of the planar-type antenna unit 70A. FIG. 27 is an exploded perspective view of the planer-type antenna unit 70A. FIG. 28 is an exploded front view of the planar-type antenna unit 70A.

The illustrated planar-type antenna unit 70A is similar in structure to the pole-type antenna unit 70 illustrated in FIGS. 16A to 16E and FIGS. 17 through 19 except that the planar-type antenna unit 70A provides with a planar-type (a disk-shaped) antenna body 10A in lieu of the pole-type antenna body 10 and structure of the universal joint is modified from that illustrated FIGS. 16A to 16E and FIGS. 17 through 19 as will later become clear. The universal joint is therefore depicted at 74A.

The planar-type antenna body 10A mounts a patch antenna (not shown) in the inside thereof.

The universal joint 74A is similar in structure to the universal joint 74 illustrated in FIGS. 16A to 16E and FIGS. 17 through 19 except that the universal joint 74A comprises a base portion 743A mounted on a bottom portion of the planar-type antenna body 10A in place of the half-cylinder 743. The grasping portion 744 is fixed to the base portion 743A at a center thereof. That is, the universal joint 74A comprises the base portion 743A as a fixing member mounted on the planar-type antenna body 10A.

FIG. 29 is an exploded perspective view showing the planar-type antenna unit 70A with the planar-type antenna body 10A side and the clip member 72 side exploded.

According to the planar-type antenna unit 70A having such a structure, it is possible to adjustably mount the planar-type antenna body 10A to a mounted portion in any orientation.

Although the ball joint 742 is provided with the clip member 72 side and the grasping portion 744 is provided with the antenna body 10A side in the second mentioned embodiment of this invention, vice versa.

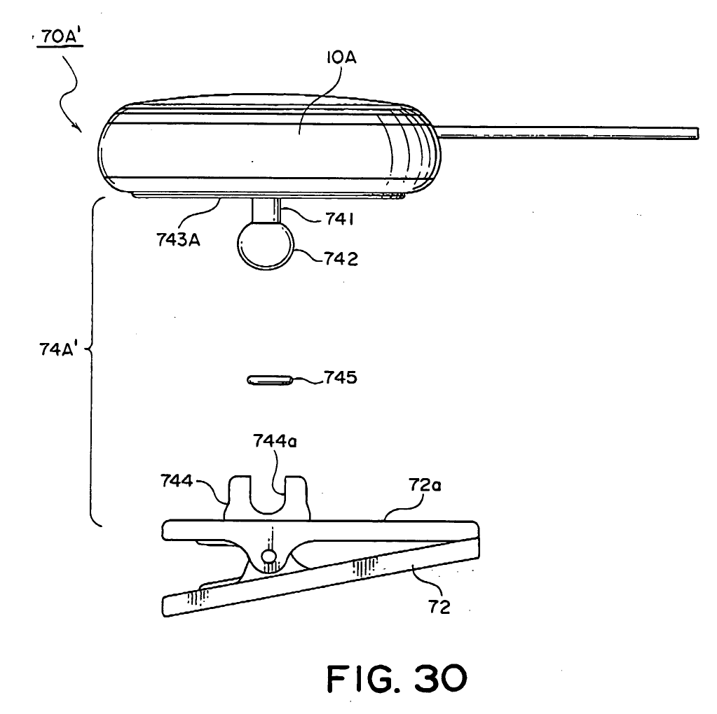

FIG. 30 is an exploded front view of a modified planar-type antenna unit 70A′. The planar-type antenna unit 70A′ comprises the planar-type antenna body 10A, the clip member 72, and a universal joint 74A′ which is modified from the universal joint 74A in the manner which will presently be described.

The universal joint 74A′ comprises the base portion 743A mounted on a bottom portion of the antenna body 10A, the extending portion 741 for extending from the base portion 743A, the ball joint 742 provided at a tip of the extending portion 741, and the grasping portion 744, which is fixed to the bottom portion 72a of the clip member 72, for grasping the ball joint 742. That is, in the planar-type antenna unit 70A′, the ball joint 742 is provided with the antenna body 10A side and the grasping portion 744 is provided with the clip member 72 side.

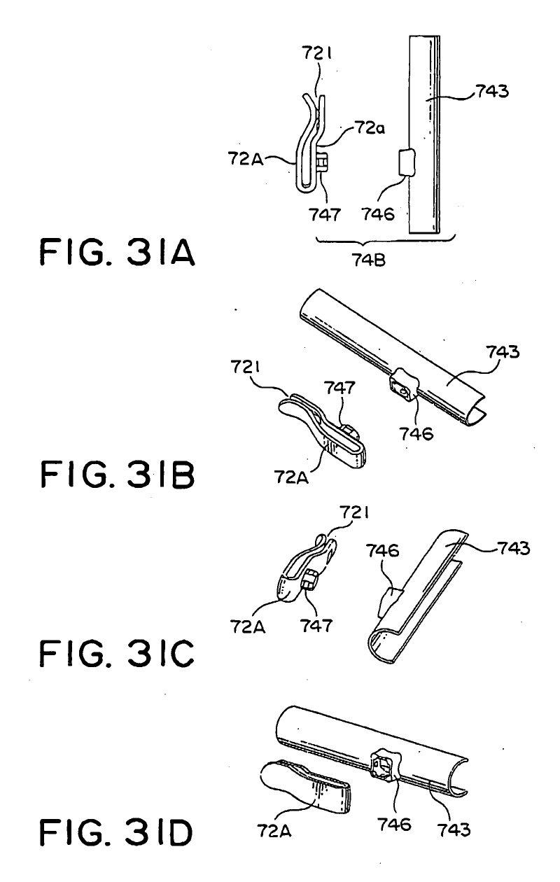

Referring to FIGS. 31A to 31D, FIGS. 32A to 32D, FIGS. 33A to 33D, and FIGS. 34A to 34D, the description will proceed to a clip member 72A and a joint member 74A for use in a pole-type antenna unit according to a third embodiment of this invention. That is, although the pole-type antenna unit according to the third embodiment of this invention comprises the pole-type antenna body 10 illustrated in FIGS. 18 and 19, illustration of the pole-type antenna body 10 is omitted in order to simplify the description. The same reference symbols are depicted to those similar to those illustrated in FIGS. 16A to 16E and FIGS. 17 through 19, only different points will be described in detail in order to simplify the description.

Used in the pole-type antenna unit 70 according to the above-mentioned first embodiment of this invention and in the planar-type antenna unit 70A according to the above-mentioned second embodiment of this invention, the clip member 72 comprises a clip of the type where an object is sandwiched by opening a pair of nipping portion by hands such as a clothespin. As contrasted with this, used in the pole-type antenna unit according to the third embodiment of this invention, the clip member 72A has a substantially U-shape and comprises a clip of the type where an objected is sandwiched by sliding.

In addition, used in the pole-type antenna unit 70 according to the above-mentioned first embodiment of this invention and in the planar-type antenna unit 70A according to the above-mentioned second embodiment of this invention, the joint members 74 and 74A comprise universal joints for movably coupling the antenna bodies 10 and 10A to the clip member 72, respectively. As contrasted with this, used in the pole-type antenna unit according to the third embodiment of this invention, the joint member 74B comprises a detachable/attachable joint for removably coupling the antenna body 10 to the clip member 72A with a variable mounting angle.

The detachable/attachable joint 73B comprises, as the fixing member mounted to the antenna body 10, the half-cylinder 743 mounted to the cylinder 40 in the similar manner of those illustrated in FIGS. 19 and 20. The clip member 72A enables to be removably mounted to the half-cylinder 743. In the example being illustrated, the clip member 72A enables to be mounted to the half-cylinder 743 with changing orientation by an angle of 90 degrees.

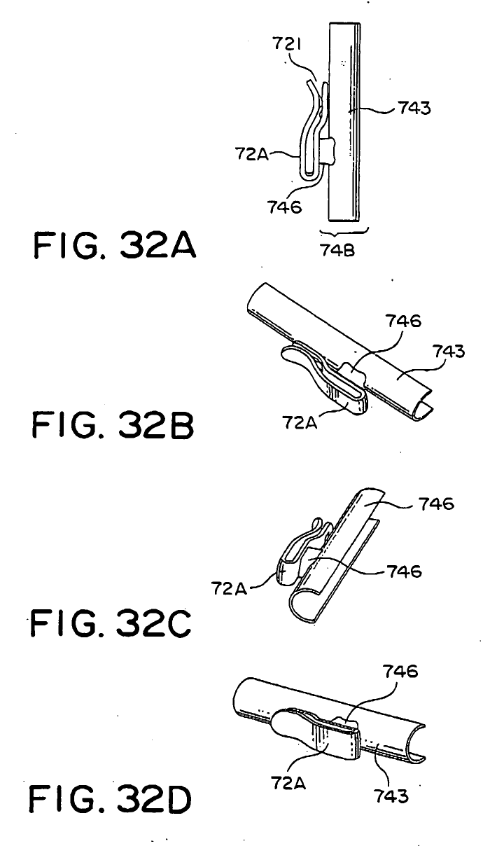

FIGS. 31A to 31D and 32A to 32D show an example where the clip member 72A is mounted to the half-cylinder 743 so that an opening 721 of the clip member 72A turns upwards with respect to the half-cylinder 743. Hereinafter, this mounting state is called an upward mounting state. FIG. 31A is an exploded right-hand side view of the upward mounting state. FIG. 31B is an exploded perspective view of the upward mounting state seen from a right-hand and forward. FIG. 31C is an exploded perspective view of the upward mounting state seen from the right-hand and rearward. FIG. 31D is an exploded perspective view of the upward mounting state seen from a front and rightward. FIG. 32A is an assembled right-hand side view of the upward mounting state. FIG. 32B is an assembled perspective view of the upward mounting state seen from a right-hand and forward. FIG. 32C is an assembled perspective view of the upward mounting state seen from the right-hand and rearward. FIG. 32D is an assembled perspective view of the upward mounting state seen from a front and rightward.

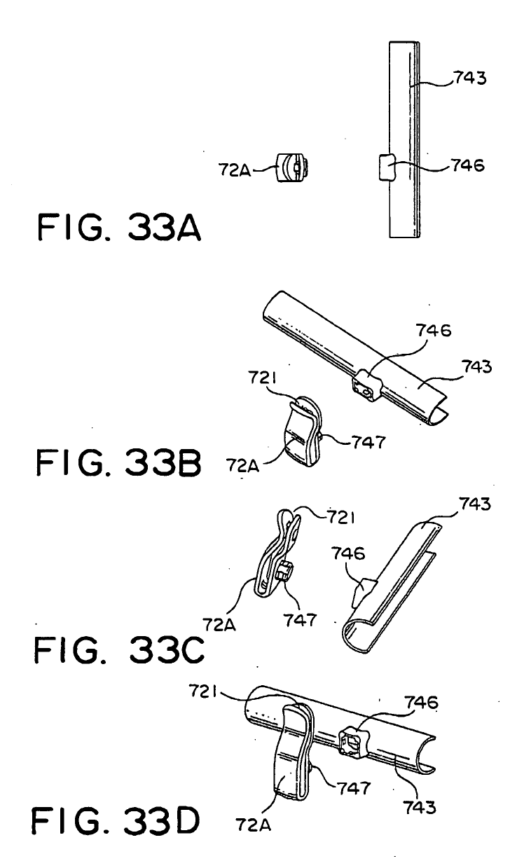

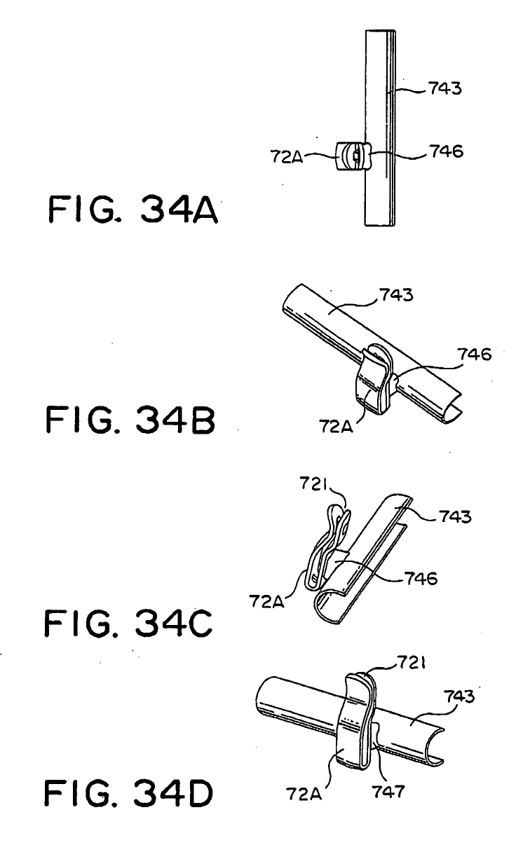

On the other hand, FIGS. 33A to 33D and 34A to 34D show an example where the clip member 72A is mounted to the half-cylinder 743 so that the opening 721 of the clip member 72A turns rightwards with respect to the half-cylinder 743. Hereinafter, this mounting state is called a rightward mounting state. FIG. 33A is an exploded right-hand side view of the rightward mounting state. FIG. 33B is an exploded perspective view of the rightward mounting state seen from a right-hand and forward. FIG. 33C is an exploded perspective view of the rightward mounting state seen from the right-hand and rearward. FIG. 33D is an exploded perspective view of the rightward mounting state seen from a front and rightward. In addition, FIG. 34A is an assembled right-hand side view of the rightward mounting state. FIG. 34B is an assembled perspective view of the rightward mounting state seen from a right-hand and forward. FIG. 34C is an assembled perspective view of the rightward mounting state seen from the right-hand and rearward. FIG. 34D is an assembled perspective view of the rightward mounting state seen from a front and rightward.

Of course, although illustrated is omitted, it is possible to mount the clip member 72A to the half-cylinder 743 so as to turn the opening 721 of clip member 72A with respect to the half-cylinder 743 downward or rightward. In other words, a downward mounting state and a leftward mounting state may be allowed.

The detachable/attachable joint 74B comprises an accepting portion 746 in lieu of the grasping portion 744 and a projection portion 747 in place of a combination of the extending portion 741 and the ball joint 742. The accepting portion 746 is fixed on the half-cylinder toward a lower portion from a central portion thereof. The projection portion 747 is fixed on a bottom portion 72a of the clip member 72A. As shown in FIGS. 32A to 32D or FIGS. 34A to 34D, by fitting the projection portion 747 in the accepting portion 746, the clip member 72A is mounted to the half-cylinder 743 with a variable mounting angle.

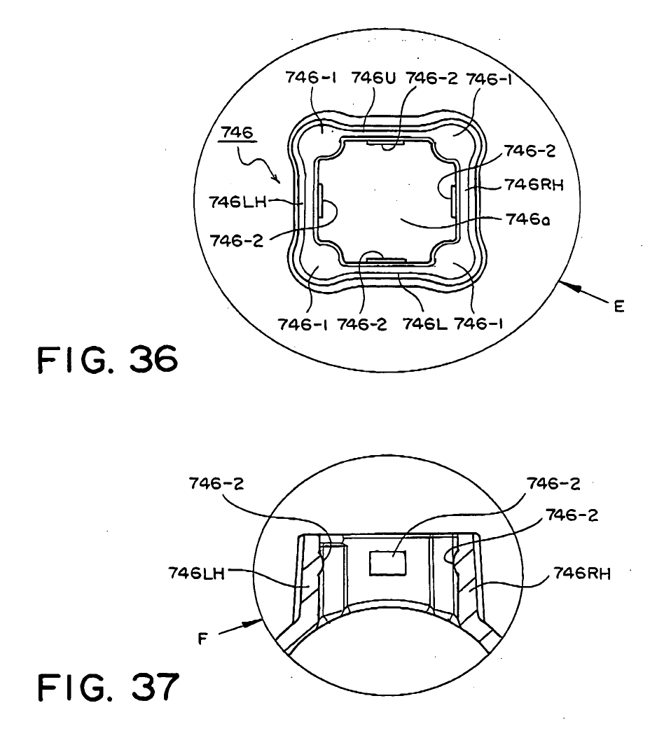

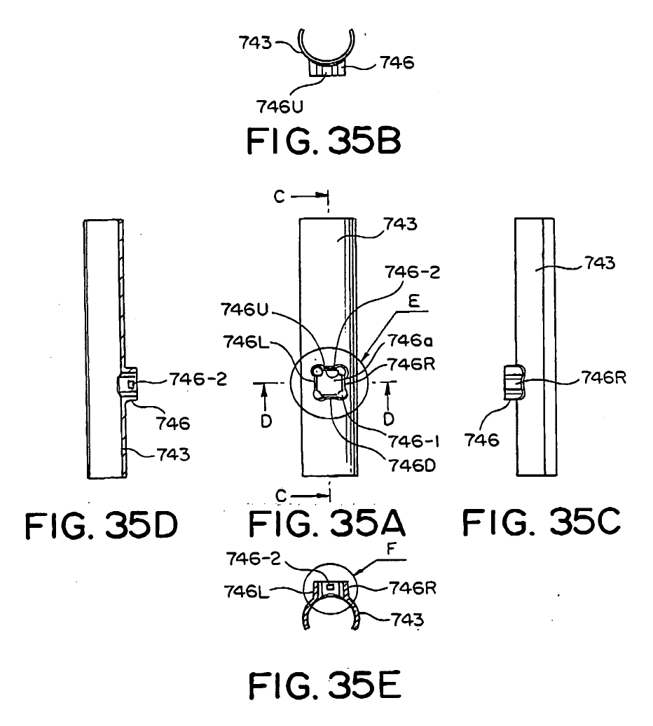

Referring now to FIGS. 35A to 35E and FIGS. 36 and 37, the description will proceed to the half-cylinder 743 with the accepting portion 746. FIG. 35A is a front view of the half-cylinder 743 with the accepting portion 746. FIG. 35B is a plan view of the half-cylinder 743 with the accepting portion 746. FIG. 35C is a right-hand side view of the half-cylinder 743 with the accepting portion 746. FIG. 35D is a cross-sectional view taken on line C-C of FIG. 35A. FIG. 35E is a cross-sectional view taken on line D-D of FIG. 35A. FIG. 36 is an enlarged view of the accepting portion 746 in a portion E enclosed with a circle of FIG. 35A. FIG. 37 is an enlarged view of the accepting portion 746 in a portion F enclosed with a circle of FIG. 35E.

The accepting portion 746 has a substantially hollow square tubular shape and has an accepting space 746a for accepting the projection portion 747, which will later be described, in an interior thereof. Specifically, the accepting portion 746 so that a diameter thereof becomes small with distance from the half-cylinder 743.

The accepting portion 746 comprises, at four corners, four solid cylindrical protrusions 746-1 for positioning the projection portion 747 which will later be described, as shown in FIG. 36. The accepting portion 746 comprises an upper accepting wall 746U, a lower accepting wall 746L, a left-hand accepting wall 746LH, and a right-hand accepting wall 746RH which connect between the four solid cylindrical protrusions 746-1. In addition, each of the upper accepting wall 746U, the lower accepting wall 746L, the left-hand accepting wall 746LH, and the right-hand accepting wall 746RH has an inner wall having an engaging projection 746-2 for removably engaging with the projection portion 747 which will later be described.

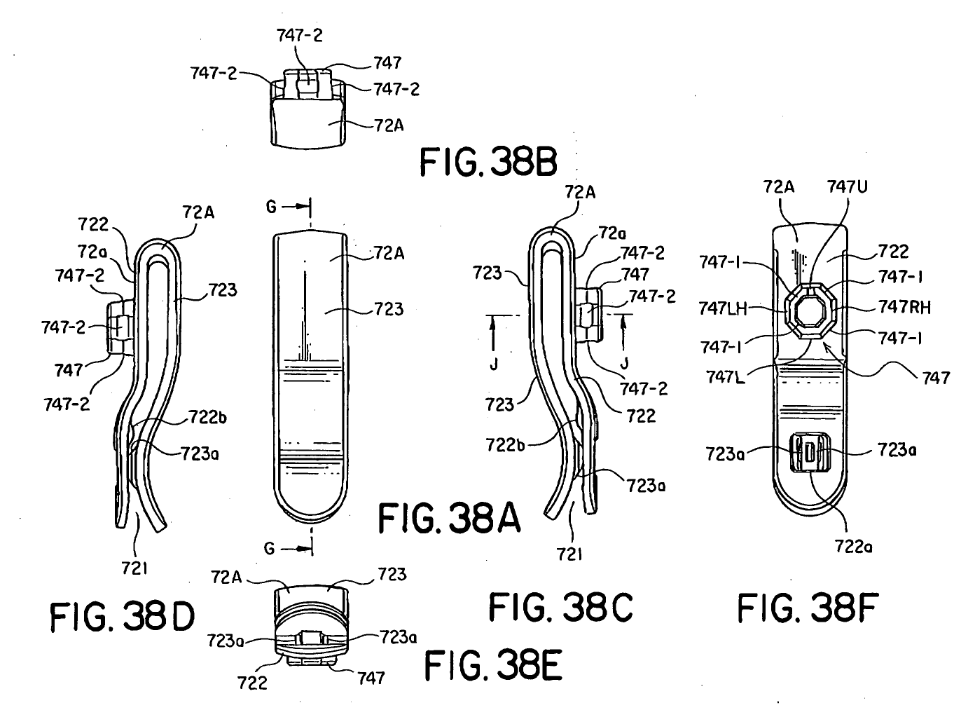

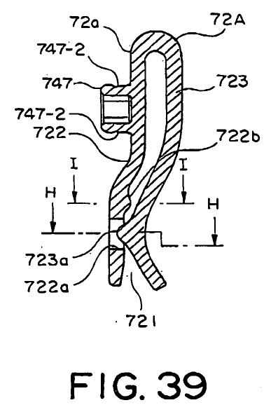

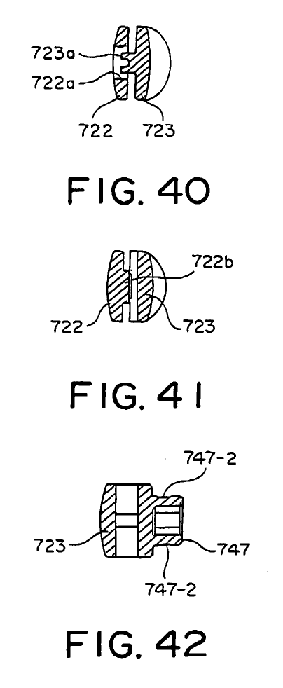

Referring now to FIGS. 38A to 38F and FIGS. 39 and 42, the description will proceed to the clip member 72A with the projection portion 747. FIG. 38A is a front view of the clip member 72A with the projection portion 747. FIG. 38B is a plan view of the clip member 72A with the projection portion 747. FIG. 38C is a right-hand side view of the clip member 72A with the projection portion 747. FIG. 38D is a left-hand side view of the clip member 72A with the projection portion 747. FIG. 38E is a bottom view of the clip member 72A with the projection portion 747. FIG. 38F is a rear view of the clip member 72A with the projection portion 747. FIG. 39 is a cross-sectional view taken on line G-G of FIG. 38A. FIG. 40 is a cross-sectional view taken on line H-H of FIG. 39. FIG. 41 is a cross-sectional view taken on line I-I of FIG. 39. FIG. 42 is a cross-sectional view taken on line J-J of FIG. 38C.

First, the description will be made about the clip member 72A. The clip member 72A has a substantially U shape and comprises a member which enables to clip an object via an opening 721. Specifically, the clip member 72A comprises a fixed piece 722 and a movable piece 723 which is movable to the fixed piece 722. The fixed piece 722 has a bottom portion 72a on which the projection portion 747, which will later be described, is fixedly mounted. In addition, in the example being illustrated, the clip member 72A and the projection portion 747 are integrally composed by injection molding.

As shown in FIGS. 39 and 40, the fixed piece 722 has a rectangular hole 722a in proximity to the opening 721. On the other hand, the movable piece 723 has a protrusion 723a which is freely fitted in the rectangular hole 722a. In addition, the fixed piece 722 has a protrusion 722b in proximity to the rectangular hole 722a in opposite side of the opening 721. The protrusion 722b projects toward the movable piece 723.

Subsequently, the description will be made about the projection portion 747. The projection portion 747 has a substantially octagonal tubular shape having a size which enables to be fitted in the accepting space 746a of the accepting portion 746. More specifically, the projection portion 747 comprises an upper projection wall 747U, a lower projection wall 747L, a left-hand projection wall 747LH, a right-hand projection wall 747RH, and four chamfered walls 747-1 for linking those walls 747U, 747L, 747LH, and 747RH. When the projection portion 747 is fitted in the accepting portion 746, outer walls of the four chamfered walls 747-1 is slidably in contact with the corresponding four solid cylindrical protrusions 746-1 of the above-mentioned accepting portion 746 so that the accepting portion 746 and the projection portion 747 are positioned to each other. Accordingly, the four chamfered walls 747-1 serves as positioning walls for positioning the accepting portion 746. In addition, each of the upper projection wall 747U, the lower projection wall 747L, the left-hand projection wall 747LH, and the right-hand projection wall 747RL has an outer wall having an engaged concave portion 747-2 which is engaged with the above-mentioned corresponding engaging projection 746-2.

According to the pole-type antenna unit comprising the clip member 72A and the joint member 74B which have such structures, it is possible to removably couple the pole-type antenna body 10 to the clip member 72A with four orientations in increments of 90 degrees. Therefore, compared with the conventional antenna unit, it is possible to mount the antenna unit to various wider portions. In addition, it is possible to receive a desired electric wave with good reception sensitivity in contradistinction to the conventional antenna unit because a mounting direction of the pole-type antenna body 10 expands.

Although, in the above-mentioned antenna unit according to the third embodiment of this invention, it is possible to change a mounting orientation of the pole-type antenna body 10 to the clip member 72A in the four orientations in increments of 90 degrees, it will be easily understood for those skilled in the art that it may change the mounting orientation in eight orientations in increments of 45 degrees by making modifications to shapes of the accepting portion 746 and the projection portion 747. Accordingly, in general, it is possible to change the orientation direction of the antenna body to the clip member in N orientations in increments of (360/N) degrees, where N represents an integer which is not less than three.

While this invention has thus far been described in conjunction with a few preferred embodiments thereof, it will now be readily possible for those skilled in the art to put this invention into various other manners. For example, although the pole-type antenna units and the planar-type antenna units described in the above-mentioned embodiments are suitable for the antenna units for use in the digital radio receiver, the antenna units according to this invention may not be restricted to those and may be applicable to an antenna unit for use in a GPS signal receiver or antenna units for use in mobile communications for receiving other satellite waves or other terrestrial waves.

What is claimed is:

1. An antenna unit comprising:
an antenna body;
a clip member; and
a joint member for coupling said antenna body to said clip member so as to enable to adjust a mounting orientation of the antenna body with respect to said clip member.

2. The antenna unit as claimed in claim 1, wherein said joint member comprises a universal joint for movably coupling said antenna body to said clip member.

3. The antenna unit as claimed in claim 2, wherein said universal joint comprises:
an extending portion for extending from a bottom portion of said clip member;
a ball joint provided to a tip of said extending portion;
a fixing member mounted on said antenna body; and
a grasping portion, fixed to said fixing member, for grasping said ball joint.

4. The antenna unit as claimed in claim 3, wherein said universal joint further comprises a non-slip ring-shaped packing disposed between said ball joint and said grasping portion.

5. The antenna unit as claimed in claim 3, wherein said antenna body comprises a pole-type antenna body having a cylinder extending up and down, said fixing portion comprising a half-cylinder mounted on said cylinder.

6. The antenna unit as claimed in claim 5, wherein said grasping portion is fixed on said half-cylinder toward a lower position from a central portion thereof.

7. The antenna unit as claimed in claim 5, wherein said grasping portion comprises an upper wall, a lower wall, a right-hand wall, and a left-hand wall, each of at least said lower wall, said right-hand wall, and said left-hand wall has a notch having a width larger than a diameter of said extending portion.

8. The antenna unit as claimed in claim 3, wherein said antenna body comprises a planar-type antenna body, said fixing member comprising a base portion mounted on a bottom portion of said planar-type antenna body.

9. The antenna unit as claimed in claim 8, wherein said grasping portion is fixed to said base portion at a center thereof.

10. The antenna unit as claimed in claim 8, wherein said grasping portion comprises four walls in all directions thereof, each of said four walls has a notch having a width larger than a diameter of said extending portion.

11. The antenna unit as claimed in claim 2, wherein said universal joint comprises:
a fixing member mounted on said antenna body;
an extending portion for extending from said fixing member;
a ball joint provided at a tip of said extending portion; and
a grasping portion, fixed to a bottom portion of said clip member, for grasping said ball joint.

12. The antenna unit as claimed in claim 11, wherein said universal joint further comprises a non-slip ring-shaped packing disposed between said ball joint and said grasping portion.

13. The antenna unit as claimed in claim 11, wherein said antenna body comprises a pole-type antenna body having a cylinder extending up and down, said fixing portion comprising a half-cylinder mounted on said cylinder.

14. The antenna unit as claimed in claim 13, wherein said extending portion is fixed on said half-cylinder toward a lower position from a central portion thereof.

15. The antenna unit as claimed in claim 11 wherein said antenna body comprises a planar-type antenna body, said fixing member comprising a base portion mounted on a bottom portion of said planar-type antenna body.

16. The antenna unit as claimed in claim 15, wherein said extending portion is fixed to said base portion at a center thereof.

17. The antenna unit as claimed in claim 1, wherein said joint member comprises a detachable/attachable joint for removably coupling said antenna body to said clip member with a variable mounting angle.

18. The antenna unit as claimed in claim 17, wherein said detachable/attachable joint comprises:
a fixing member mounted on said antenna body;
an accepting portion mounted on said fixing member; and
a projection portion mounted on said clip member, said projection portion being fitted in said accepting portion.

19. The antenna unit as claimed in claim 18, wherein said antenna body comprises a pole-type antenna body having a cylinder extending up and down, said fixing portion comprising a half-cylinder mounted on said cylinder.

20. The antenna unit as claimed in claim 19, wherein said accepting portion is fixed on said half-cylinder toward a lower position from a central portion thereof.

21. The antenna unit as claimed in claim 18, wherein said clip member enables to be mounted on said fixing member with changing an orientation of said clip member by an angle of (360/N) degrees, where N represents an integer which is not less than three.

22. The antenna unit as claimed in claim 21, wherein the integer N is equal to four, said clip member enabling to be mounted on said fixing member with changing the orientation of said clip member by the angle of 90 degrees.

23. The antenna unit as claimed in claim 22, wherein said accepting portion has a substantially hollow square tubular shape and has an accepting space for accepting said projection portion in an interior thereof, and
where said projection portion has a substantially octagonal tubular shape having a size which enable to be fitted in the accepting space of said accepting portion.

24. The antenna unit as claimed in claim 23, wherein said accepting portion comprises, at four corners thereof, four cylindrical protrusions for positioning said projection portion and an upper accepting wall, a lower accepting wall, a left-hand accepting wall, and a right-hand accepting wall which connect between said four cylindrical protrusions, and
where said projection portion comprises an upper projection wall, a lower projection wall, a left-hand projection wall, a right-hand projection wall, and four chamfered walls for linking between said upper projection wall, said lower projection wall, said left-hand projection wall, and said right-hand projection wall to be slidably in contact with said four cylindrical protrusions.

25. The antenna unit as claimed in claim 24, wherein each of said upper accepting wall, said lower accepting wall, said left-hand accepting wall, and said right-hand accepting wall of said accepting portion has an inner wall having an engaging projection for removably engaging with said projection portion,
wherein each of said upper projection wall, said lower projection wall, said left-hand projection wall, and said right-hand projection wall of said projection portion has an outer wall having an engaged concave portion which is engaged with the corresponding engaging projection.
